(19) United States
(12) Patent Application Publication
(10) Pub. No.: US 2011/0134181 A1
(43) Pub. Date: Jun. 9, 2011

(54) Inkjet printer

(75) Inventors: Sung Il Oh, Seoul (KR); Dong Hoon Kim, Seongnam (KR); Byoung Jin Chun, Suwon (KR); Su Hwan Cho, Seoul (KR)

(73) Assignee: SAMSUNG ELECTRO-MECHANICS CO., LTD., Suwon (KR)

(21) Appl. No.: 12/805,194

(22) Filed: Jul. 16, 2010

(30) Foreign Application Priority Data
Dec. 9, 2009 (KR) 10-2009-0121834

(51) Int. Cl. B41J 2/015

(52) U.S. Cl. 347/20

(57) ABSTRACT

An inkjet printer includes: a cartridge body provided with an ink chamber; a head unit coupled to a bottom surface of the cartridge body and provided with nozzles for jetting ink; and an energy irradiation unit coupled to the cartridge body so as to irradiate energy onto the ink jetted from the nozzles of the head unit.

### CROSS-REFERENCE TO RELATED APPLICATIONS

This application claims the priority of Korean Patent Application No. 10-2009-0121834 filed on Dec. 9, 2009, in the Korean Intellectual Property Office, the disclosure of which is incorporated herein by reference.

### BACKGROUND OF THE INVENTION

1. Field of the Invention

The present invention relates to an inkjet printer, and more particularly, to an inkjet printer of which the printing pattern has excellent high degree of precision and which quickly completes a printing process.

2. Description of the Related Art

As demands for a method for manufacturing an electronic device at a low cost have recently increased, a great deal of attention is being paid to a low-cost pattern formation process such as a printing technology.

An inkjet printing technology is a digital printing technology which does not require an exposure process. Much research is being conducted into manufacturing an electronic device through inkjet printing technology. In particular, with the development of nanotechnology, ink made of nano metals may be jetted through an inkjet head to form a pattern. Then, the pattern may be baked at a low temperature of around 200° C. to obtain a low-cost conductive pattern.

However, the conductive pattern obtained through the inkjet printing has a small thickness. Therefore, a large number of printing processes should be repetitively performed to form interconnections of a printed circuit board requiring a large interconnection thickness. Accordingly, productivity inevitably decreases.

When a large amount of ink is jetted to increase the thickness of the conductive pattern, it is difficult to implement a precise pattern. Furthermore, the ink may spread.

When the amount of solvent content is reduced to increase a solid content in ink to be jetted, it is difficult to obtain a viscosity suitable for jetting.

### SUMMARY OF THE INVENTION

An aspect of the present invention provides an inkjet printer which quickly evaporates a solvent from jetted ink to increase a solid content such that a printed pattern has an excellent precision and a printing process may be quickly completed.

According to an aspect of the present invention, there is provided an inkjet printer including: a cartridge body provided with an ink chamber; a head unit coupled to a bottom surface of the cartridge body and provided with nozzles for jetting ink; and an energy irradiation unit coupled to the cartridge body so as to irradiate energy onto the ink jetted from the nozzles of the head unit.

The energy irradiation unit may include: an energy supply unit; an energy transmission unit having an end connected to the energy supply unit; and an energy emission unit connected to the other end of the energy transmission unit and emitting energy transmitted from the energy supply unit.

The energy emission unit may include an emission unit body emitting energy and a lens provided on a front surface of the emission unit body.

The lens may include any one of a cylinder lens, a concave lens, and a line generator.

The energy emission unit may be provided under a longitudinal side surface of the cartridge body.

The energy emission unit may be provided under both widthwise side surfaces of the cartridge body.

The energy emission unit may be coupled to a yoke portion formed on an outer surface of the cartridge body.

The energy emission unit may be built in the cartridge body.

The energy emission unit may be provided on an inclined surface formed from a predetermined position of the bottom surface of the cartridge body to a predetermined position of a side surface of the cartridge body.

The energy transmission unit may be formed of an optical fiber.

The energy irradiated from the energy irradiation unit may include any one of laser and infrared light.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of an inkjet printer according to an embodiment of the present invention;

FIG. 2A is a plan view of the inkjet printer according to the embodiment of the present invention;

FIG. 2B is a front view of the inkjet printer according to the embodiment of the present invention;

FIG. 3 is a perspective view of an inkjet printer according to another embodiment of the present invention;

FIG. 4A is a plan view of the inkjet printer according to the embodiment of the present invention;

FIG. 4B is a front view of the inkjet printer according to the embodiment of the present invention;

FIG. 5A is a side view of an inkjet printer according to another embodiment of the present invention;

FIG. 5B is a plan view of the inkjet printer according to the embodiment of the present invention;

FIG. 6 is a front view of an inkjet printer according to another embodiment of the present invention;

FIG. 7 is a front view of an inkjet printer according to another embodiment of the present invention;

FIG. 8 is a perspective view of an inkjet printer according to another embodiment of the present invention;

FIG. 9 is a photograph obtained by photographing a pattern printed by a general inkjet printer; and

FIG. 10 is a photograph obtained by photographing a pattern printed by the inkjet printer according to the embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the thicknesses of layers and regions are exaggerated for clarity. Like reference numerals in the drawings denote like elements, and thus their description will be omitted.

In the entire specification, it should be noted that when a portion “is connected to” other portions, the portion can be directly connected to the other portions or indirectly connected to the other portions with intervening any of elements present. In addition, it should be noted that a phrase that a portion “includes” an element(s) means that the portion does not exclude but include the other elements unless otherwise stated herein.

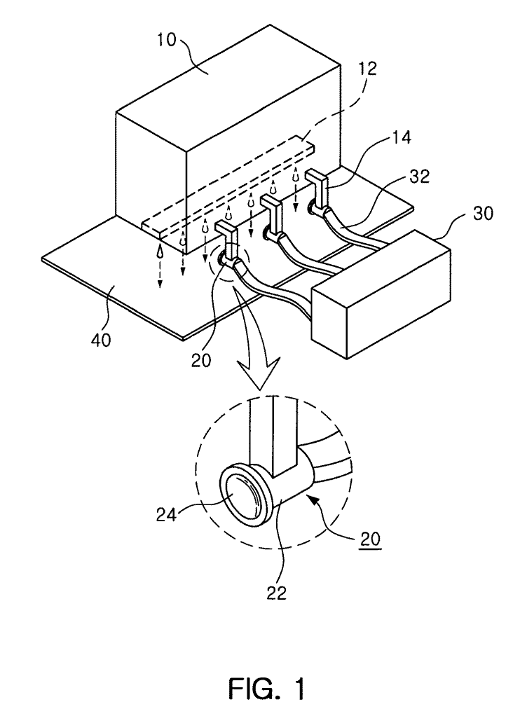

FIG. 1 is a perspective view of an inkjet printer according to an embodiment of the present invention.

Referring to FIG. 1, the inkjet printer according to the embodiment of the present invention may include a cartridge body 10, a head unit 12, an energy emission unit 20, an energy transmission unit 32, and an energy supply unit 30.

The cartridge body 10 may include an ink chamber (not shown) formed therein to contain ink.

The head unit 12 may include a plurality of nozzles which are provided on the bottom surface of the cartridge body 10 so as to jet ink.

The energy supply unit 30 may supply energy which is to be irradiated onto the jetted ink.

At this time, the energy supplied by the energy supply unit 30 may be laser or infrared light.

FIG. 1 illustrates that the energy supply unit 30 is spaced apart from the cartridge body 10. Without being limited thereto, however, the energy supply unit 30 may be coupled to the cartridge body 10 or formed integrally with the cartridge body 10.

The energy transmission unit 32 may have an end connected to the energy supply unit 30 and the other end connected to the energy emission unit 20 and may transmit the energy supplied from the energy supply unit 30 to the energy emission unit 20.

The energy emission unit 20 may emit the energy transmitted from the energy transmission unit 32 to irradiate onto the ink jetted from the head unit 12.

The energy emission unit 20 may include an emission unit body 22 and a lens 24. The emission unit body 22 may include a structure capable of emitting energy. The energy emitted from the inside of the emission unit body 22 may spread to a wide area while passing through the lens 24 provided on a front surface of the emission unit body 22. FIG. 1 illustrates that the lens 24 is a concave lens. However, the lens 24 is not limited thereto.

The energy emission unit 20 may be coupled to the cartridge body 10 through a yoke portion 14.

The energy emission unit 20 may be fixed in a specific direction or adjusted in four directions so as to irradiate energy onto the ink which is jetted from the head unit 12 to be dropped onto a print sheet 40.

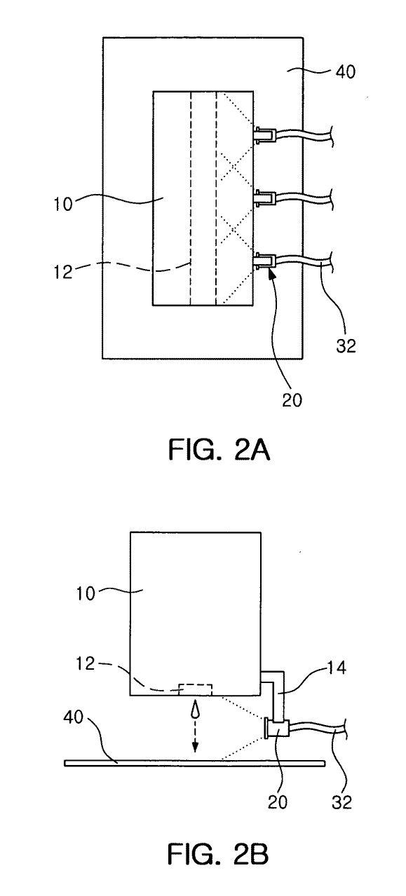

FIG. 2A is a plan view of the inkjet printer according to the embodiment of the present invention. FIG. 2B is a front view of the inkjet printer according to the embodiment of the present invention.

In FIGS. 2A and 2B, an area onto which the energy emitted from the energy emission unit 20 is irradiated is illustrated with dotted lines.

Referring to FIG. 2A, the inkjet printer according to the embodiment of the present invention may include three energy emission units 20 which are provided on one longitudinal side surface of the cartridge body 10 so as to irradiate energy onto the entire head unit 12.

Referring to FIG. 2B, the energy emitted from the energy emission unit 20 of the inkjet printer according to the embodiment of the present invention may be irradiated onto ink jetted from the head unit 12 until the ink reaches the print sheet 40.

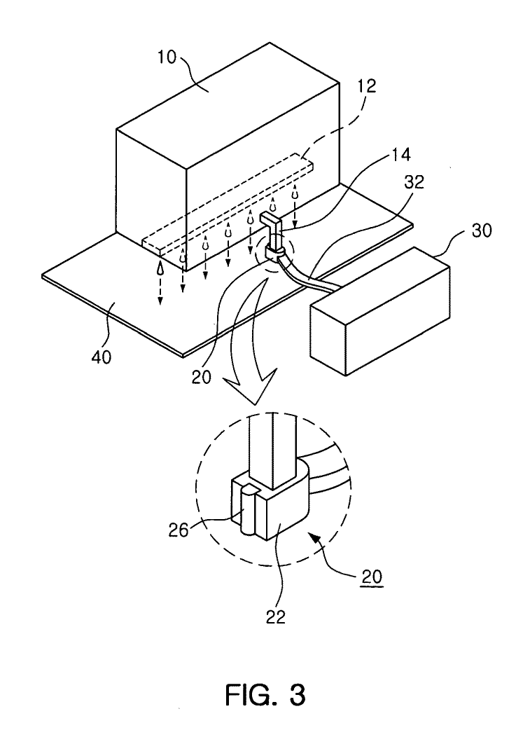

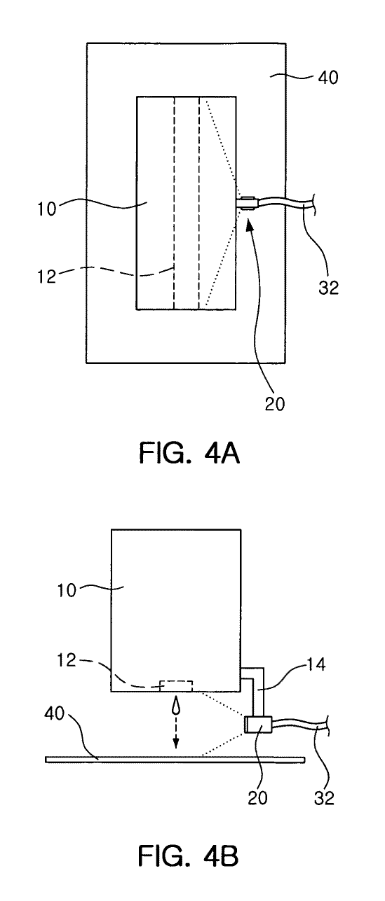

FIG. 3 is a perspective view of an inkjet printer according to another embodiment of the present invention. FIG. 4A is a plan view of the inkjet printer according to the embodiment of the present invention. FIG. 4B is a front view of the inkjet printer according to the embodiment of the present invention.

In the inkjet printer illustrated in FIG. 3, only the construction and number of energy emission units 20 are different from those of the energy emission units of the inkjet printer illustrated in FIG. 1. Therefore, the detailed descriptions of the same components will be omitted.

Referring to FIG. 3, the energy emission unit 20 of the inkjet printer according to the embodiment of the present invention may include a cylinder lens 26 provided on a front surface of the emission unit body 22.

In the case of the cylinder lens, the width of an area upon which energy is irradiated is larger than that of a concave lens. Therefore, only a smaller number of energy emission units 20 may be used to irradiate energy onto ink jetted from the entire head unit 12. FIG. 3 illustrates that one energy emission unit 20 is provided.

Referring to FIG. 4A, it can be seen that when the cylinder lens 26 is used, only one energy emission unit 20 may be used to irradiate energy onto the entire area of the head unit 12.

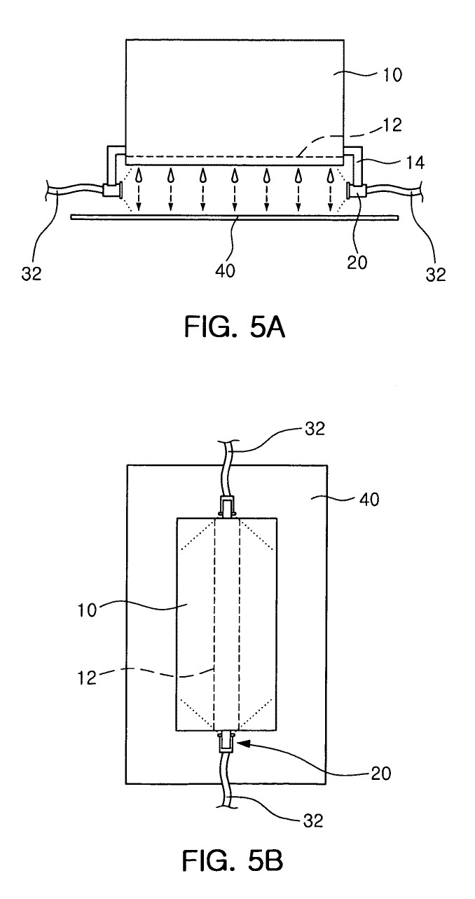

FIG. 5A is a side view of an inkjet printer according to another embodiment of the present invention. FIG. 58 is a plan view of the inkjet printer according to the embodiment of the present invention.

The inkjet printer illustrated in FIGS. 5A and 5B is different from the inkjet printer illustrated in FIG. 1 only in that an energy emission unit 20 is provided on both widthwise side surfaces of the cartridge body 10. Therefore, the detailed descriptions of the same components will be omitted.

Referring to FIGS. 5A and 5B, the inkjet printer according to the embodiment of the present invention may include an energy emission unit 20 provided on both widthwise side surfaces of the cartridge body 10 to irradiate energy onto ink jetted from the head unit 12.

At this time, the lens provided on the energy emission unit 20 may be a concave lens or cylinder lens.

Although not illustrated, the energy emission unit 20 may be additionally provided on a longitudinal side surface of the cartridge body.

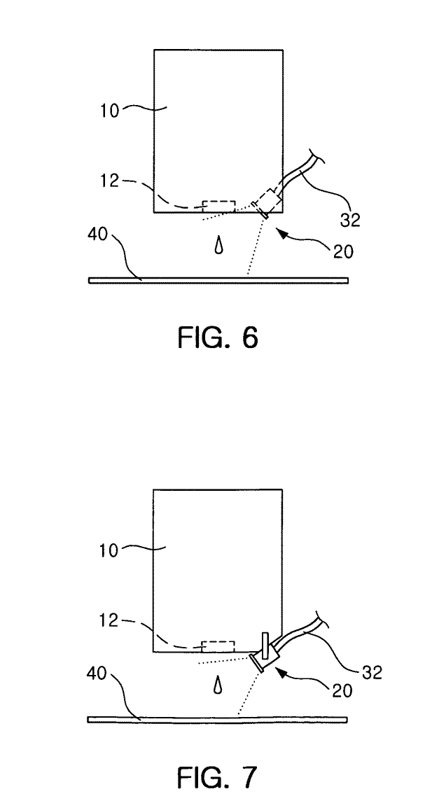

FIG. 6 is a front view of an inkjet printer according to another embodiment of the present invention.

Referring to FIG. 6, the inkjet printer according to the embodiment of the present invention may include an energy emission unit 20 provided inside the cartridge body 10. Therefore, the inkjet printer may be reduced in size.

FIG. 7 is a front view of an inkjet printer according to another embodiment of the present invention.

Referring to FIG. 7, the inkjet printer according to the embodiment of the present invention includes an energy emission unit 20 provided on an inclined surface formed from a predetermined position of the bottom surface of the cartridge body 10 to a predetermined position of a side surface of the cartridge body 10. Therefore, the inkjet printer may be reduced in size.

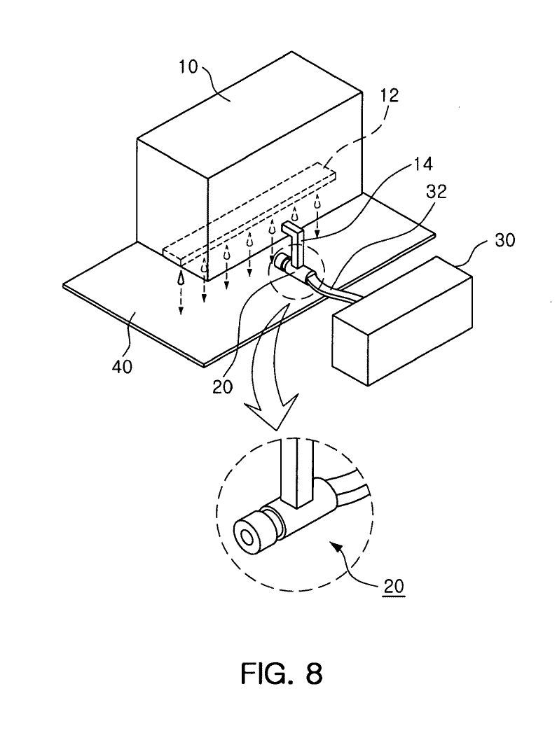

FIG. 8 is a perspective view of an inkjet printer according to another embodiment of the present invention.

The inkjet printer illustrated in FIG. 8 is different from the inkjet printer illustrated in FIG. 3 only in that a line generator is used as the energy emission unit 20.

Meanwhile, the line generator is similar to the cylinder lens in that the line generator may irradiate energy onto a wide area. Therefore, the construction thereof is the same as that described in FIGS. 4A and 4B.

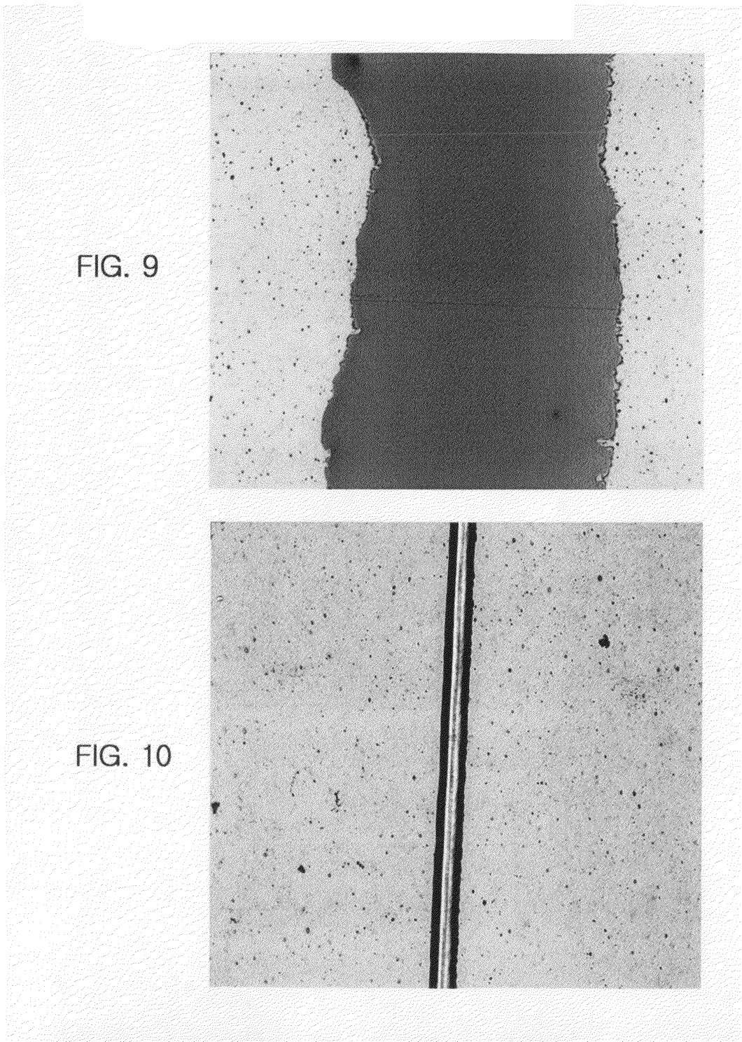

FIG. 9 is a photograph obtained by photographing a pattern printed by a general inkjet printer. FIG. 10 is a photograph obtained by photographing a pattern printed by the inkjet printer according to the embodiment of the present invention.

To form the printed pattern shown in FIG. 10, an inkjet head including 256 nozzles with a diameter of 30 μm was used, a line generator was used as the energy emission unit, an optical fiber was as the energy transmission unit, and a CO₂ laser generation device was used as the energy supply unit.

The printed pattern of FIG. 9 has a line width of about 742 μm, and the printed pattern of FIG. 10 has a line width of about 70 μm. That is, the line width of the printed pattern of FIG. 9 is approximately ten times larger than that of the printed pattern of FIG. 10.

The printed pattern of FIG. 9 is formed to a height of 1 μm or less, and the printed pattern of FIG. 10 is formed to a height of 7.5 μm. That is, the printed pattern of FIG. 9 is formed to have a much smaller height than the printed pattern of FIG. 10.

In the inkjet printer according to the embodiment of the present invention, the energy irradiation unit coupled to the cartridge body irradiates energy onto ink jetted from the head unit such that a solvent is quickly evaporated from the jetted ink. Then, the amount of solid content may increase in the ink.

Therefore, a precise printing pattern may be implemented. Furthermore, as the jetted ink is quickly dried to shorten the time required for the printing process, it is possible to improve productivity.

While the present invention has been shown and described in connection with the exemplary embodiments, it will be apparent to those skilled in the art that modifications and variations can be made without departing from the spirit and scope of the invention as defined by the appended claims.

What is claimed is:

1. An inkjet printer comprising:
a cartridge body provided with an ink chamber;
a head unit coupled to a bottom surface of the cartridge body and provided with nozzles for jetting ink; and
an energy irradiation unit coupled to the cartridge body so as to irradiate energy onto the ink jetted from the nozzles of the head unit.

2. The inkjet printer of claim 1, wherein the energy irradiation unit comprises:
an energy supply unit;
an energy transmission unit having an end connected to the energy supply unit; and
an energy emission unit connected to the other end of the energy transmission unit and emitting energy transmitted from the energy supply unit.

3. The inkjet printer of claim 2, wherein the energy emission unit comprises:
an emission unit body emitting energy; and
a lens provided on a front surface of the emission unit body.

4. The inkjet printer of claim 3, wherein the lens comprises any one of a cylinder lens, a concave lens, and a line generator.

5. The inkjet printer of claim 2, wherein the energy emission unit is provided under a longitudinal side surface of the cartridge body.

6. The inkjet printer of claim 2, wherein the energy emission unit is provided under both widthwise side surfaces of the cartridge body.

7. The inkjet printer of claim 2, wherein the energy emission unit is coupled to a yoke portion formed on an outer surface of the cartridge body.

8. The inkjet printer of claim 2, wherein the energy emission unit is built in the cartridge body.

9. The inkjet printer of claim 2, wherein the energy emission unit is provided on an inclined surface formed from a predetermined position of the bottom surface of the cartridge body to a predetermined position of a side surface of the cartridge body.

10. The inkjet printer of claim 2, wherein the energy transmission unit is formed of an optical fiber.

11. The inkjet printer of claim 1, wherein the energy irradiated from the energy irradiation unit comprises any one of laser and infrared light.
